(19) United States
(12) Patent Application Publication
(10) Pub. No.: US 2005/0060365 A1
(43) Pub. Date: Mar. 17, 2005

(54) Context-based information processing

(76) Inventors: Scott L. Robinson, Portland, OR (US); Uttam Sengupta, Portland, OR (US); Andrew V. Anderson, Hillsboro, OR (US); Steven M. Bennett, Hillsboro, OR (US); Paul R. Pierce, Portland, OR (US); Trevor A. Pering, Mountain View, CA (US); Nicholas D. Wade, Portland, OR (US); Shreekant S. Thakkar, Portland, OR (US); Kit Y. Tham, Portland, OR (US)

Correspondence Address: John P. Ward, Esq.;BLAKELY, SOKOLOFF, TAYLOR & ZAFMAN LLP, Seventh Floor, 12400 Wilshire Boulevard, Los Angeles, CA, 90025-1026, US

(21) Appl. No.: 10/057,163

(22) Filed: Jan. 24, 2002

(51) Int. Cl. G06F 15/16

(52) U.S. Cl. 709/203

(57) ABSTRACT

Methods and apparatus are provided for processing information items. Processing comprises one of context filtering, context prioritizing, or both context filtering and context prioritizing. In some embodiments the set of context items from which processing criteria are derived includes a user's calendar of appointments, schedule changes, exceptions, and the like.

### FIELD OF THE INVENTION

The field is information aggregation, processing, distribution and transfer.

### BACKGROUND OF THE INVENTION

Devices such as information storage repositories, servers, computers, stationary computing devices, portable computing devices and/or display devices such as personal digital assistants, monitors, cell phones, and laptop computers (all the preceding are collectively referred to as “devices” herein; each may also be referred to as a “device”) may be operative to retrieve information. The devices may retrieve in formation from from one or more servers, computers, Internet sources, sensors/measurement sources, sensor networks, or other information sources and information storage repositories which may or may not be at different physical locations. Typically information is transferred from an information source to a device in a single uninterrupted transfer of information, until such time as the transfer is complete. The information is transferred over one or more transfer mediums such as wired, wireless, optical, inductive loop, or other network connections. There is a need to process the information that is transferred so as to provide information more relevant to the user of a device.

### BRIEF DESCRIPTION OF THE DRAWINGS

The invention is illustrated by way of example, and not by way of limitation, in the figures of the accompanying drawings in which like reference numerals refer to similar elements.

FIG. 1 is a block diagram flowchart of a context-based processing system, including a context filter and context-based prioritizer, according to an embodiment.

FIG. 2 is a block diagram flowchart of a context-based transfer process, according to an embodiment.

FIG. 3 is a block diagram flowchart of a phased transfer process, according to an embodiment.

FIG. 4 is a block diagram flowchart of a single phase of a phased transfer process, according to an embodiment. FIG. 5 is an embodiment of a system, according to the invention. FIG. 6 is an alternative embodiment of a system, according to the invention.

### DETAILED DESCRIPTION

Methods and apparatuses for processing, distributing, synchronizing, and presenting context-sensitive information are described.

Users are inundated with information from an array of sources: email, news, the Internet/World Wide Web, computer networks, etc. Additionally, users have a variety of computing and communication facilities at their disposal: mainframes, servers, workstations, desktop PCs, electronics game and settop boxes, cellular phones, pagers, Personal Information Managers (PIMs)/Personal Digital Assistants (PDAs), laptop computers, etc. Some of these devices are at a fixed location (e.g. desktop PCs) and some travel with the user (e.g. cell phones). These devices may access information from a wide array of information sources. Devices may be limited in their ability to accomplish computational tasks, present information, and communicate with other devices due to factors that comprise monetary costs, display constraints (e.g. size), power capacity and consumption rates (e.g. battery capacity), high-cost and/or low-bandwidth communication channels, computation capabilities, local storage size, etc. For example, a battery-powered cellular phone has limited standby and talk times due to limited battery reserves as well as often featuring small displays only capable of presenting a few characters or small images at any given instant. System limitations and failures, such as loss of wireless connectivity, can interrupt or prematurely terminate information transfers. This can result in important information not being made available to the user at the right time.

It would be advantageous to coordinate and automate information exchange between devices and to select timely, relevant, personalized information that is presented to the user or used for determining the form of presentation to the user. Additionally, it would be advantageous to determine what information should be transferred between devices and to prioritize information to be transferred, and, based on the prioritization established, to determine an order for the transfer of information. As circumstances change, it would be advantageous to filter and prioritize the information to be transferred again. Lastly, it would be advantageous to filter the information to be transferred and to prioritize the ordering of the information to be output to the user, and to repeatedly filter and prioritize the ordering as circumstances change.

A computer-implemented management service (“service” herein) may, for instance:
retrieve information that is potentially pertinent to one or more users from one or more information sources comprising one or more servers, computers, Internet sources, sensors/measurement sources, sensor networks, or other information sources and information storage repositories. Users and devices participating in the service (including the local device) may be sources of information;
filter and/or prioritize information presented to a user, so as to present highly pertinent information and to reduce or eliminate, for presentation, information deemed to be of little or no immediate relevance;
reduce tasks to be carried out by the user, through informed, automated decision-making and/or execution of tasks that would otherwise require execution by the user;
Proactively search, retrieve and deliver information deemed relevant, or potentially relevant to the user at a future time.

The service may simplify a user's life by reducing the user's cognitive load, allowing the user to focus on other tasks of higher priority. The service may reduce a user's effort expended (e.g. time and energy) to get relevant information, thereby increasing the ability to react to changing circumstance. The service may, for instance, reduce or eliminate the number of hyperlink links a user must traverse to retrieve information within a hyperlink-accessed environment (e.g. the World Wide Web) by “prefetching,” i.e., searching and retrieving relevant or related materials, before they are requested. For example, the service may notify a user that their airline flight has been cancelled, and also provide a set of rebooking alternatives from which to choose. The service may be anticipatory, suggestive, adaptive, proactive, personalized to the needs of a user; it may, for instance, adjust user profile and preferences over time by tracking user activity (e.g. browsing selections, location, , etc).

The following terms are defined as used herein.
Users: A user herein refers to one or more living or non-living entities. Examples of living entities include an individual, a group of individuals such as a family, a network, a business unit, etc. Examples of non-living entities include machines, computing devices, information storage repositories, software agents, mechanical control systems and actuators, etc.
Intelligent agents: These entities proactively monitor a variety of local and network-based information sources (e.g. Web) on the user's behalf, notifying the user of items of interest that may include information comprising activities and events, including exceptions. Exceptions comprise unexpected, non-standard, non-characteristic or erroneous activities, events or changes. The cancellation of an airline flight is an example of event that is an exception for the user.
Context: Information about the user and the world that is used to process information potentially of interest to the user.
Rules: One or more sets of logical rules for processing (e.g. evaluating, filtering and prioritizing) information in light of context.
Information Items: Data that may comprise news, weather, email, activities, events, including exceptions, etc. potentially of interest to one or more users. Information items may also comprise queries posed to one or more users and information regarding a user's use of the service (i.e. what information was viewed, in what order was it viewed, etc.).
Transfer Mediums: Communication paths (and associated communication devices) between devices. This may comprise wired, wireless, optical, inductive loop or other networks or direct connection between devices and associated protocols.
Storage: typically hardware, to store the information items, context and other related software, rules, and state, as necessary. This may include, but is not limited to, RAM, ROM, flash memory, rotating disk or any other biological- chemical-, electrical-, optical-, mechanical-, or quantum-based storage mechanism.
Devices: A device is any computing or presentation device associated with a service. Devices may be operative to transfer information through a transfer medium. A device may comprise a single unit or multiple units, some of which may be in active communication and/or actively performing activities and/or actions related to decision-making. A device may comprise a presentation device that is operative to present information, such as visual, audio, tactile, olifactory, etc. For example, a device may include, but is not limited to, a liquid crystal display (LCD) screen, an audio speaker or phone, or Braille output device. Other devices such as a laptop computer, PDA or cell phone may comprise more substantive processing (storage, presentation, etc) capabilities. In this case, information may be transferred to the device, which may perform additional processing on the information received. A device may be utilized to practice an embodiment of the invention. A device may accept input through a variety of mechanisms including, e.g. keyboards, microphones, tactile mechanisms, etc. A device may comprise sensors and transducers such as, e.g., a location sensor such as a GPS (Global Positioning System) receiver or network-based location determination mechanism, temperature sensor, accelerometer, etc. A device may: remain in the proximity of a user (e.g. during periods of travel, time away from the office, etc.); travel with the user (e.g. a laptop computer, PDA, pager, cell phone, etc); or remain at a fixed location (e.g. desktop personal computer (PC), information kiosk, telephone, etc.).

By way of example, and not by limitation, devices are sometimes referred to as “servers” or “clients” as might be found in well-known client-server computing systems, where the server may have ample computational assets (memory, storage, computing power) and access to a plethora of information sources. Other service system organizations are possible; for example, systems comprising devices with comparable computing capabilities and access to similar information sources as might be found in a peer-to-peer system. The use of the terms “server” and “client” is for clarity of illustration and not one of restriction.

Discussions herein also refer to “source device” and “receiving device” for clarity of description and illustration by way of example, and not by limitation. Since the mechanism here may involve bi-directional flow of information between devices, these terms are often used to designate the net flow of information at a given point, but may refer to a unidirectional flow of information. For unidirectional information flow, one device sends information, while the other device receives. For net flow, both devices are sending and receiving information, but at any one instant of time, the one sending information is considered to be the “source device”. Information transfers, whether unidirectional or bidirectional, are also, herein, referred to as “transfers”.

Upon receiving information items, a device may, for example, act by formatting and presenting some portion of the information to a user. The receiving device may further process the information items, resulting in a modified presentation to the user or transfer to another device. Authentication may be required in order to restrict access to the received information and/or presentation based upon received information; such authentication may be accomplished via, e.g., secret password, cryptographic key, biometrics (such as iris scanning, speaker verification or fingerprint analysis), or other authentication methods. Devices may also act on the received information by processing, and, for example, execute tasks via interfaces with robotic, transducing, or other such mechanisms that accept commands from an information handling device, and that also may perform physical functions, e.g., home control, home security, vehicular control, manipulation of physical objects, etc.

Logical rules (“rules” herein) may comprise business process rules, social/cultural process rules and laws (e.g. religious food practices), natural laws (e.g. laws of physics), and policies that may be used in conjunction with context to perform tasks that comprise selecting information of interest, filtering information, prioritizing information, and generating new information. Logical rules may also be used to specify personal or group classification and prioritization criteria, processes and policies. For example, a service may have policies such as: A) always maintain 10% free space (disk or memory) on a device to which information is being transferred; or B) permit transfer of large files after 7:00 PM over the air since rates are lower. Another example would be a set of logical rules to assist in classifying the importance of an email message. For example, a given rule may indicate that urgent messages from an individual's spouse should be classified as very important, while messages containing the phrase “make money fast” are to be classified as of lower importance. A set of logical rules may be augmented or reduced as deemed appropriate by the service for effecting better execution of service functioning.

Logical rules may be components of inference engines, Bayesian analyzers, neural nets, etc. or may be coded directly into the service. Logical rules may be provided by, for example, the system's designers or administrators, users or their agents.

Rule evaluation and analysis permit handling and/or resolving inconsistencies in context, information and the rules. Inconsistencies in context or information can arise, for instance, because of user error, incorrect information, information from multiple, independent sources that disagree, incorrectly written rules, conflicting rule sets for different situations, etc.

Informational items comprise data that is potentially of interest to one or more users. Informational items (“information” or “information items” herein) to be monitored typically include data from user-specific (e.g. personal) and non-user-specific sources that is potentially pertinent to one or more users. Non-user-specific information sources include items such as movies, music, photos, fiction and non-fiction literature, weather conditions, traffic conditions, changes in others' calendar appointments that may impact the user's schedule, e.g., changes in travel and accommodation services, emergencies, unforeseen political crises, stock-market conditions, etc. User-specific information sources may comprise email received by the user, entries in the user's calendar, personal profile information, travel history, etc. Information items therefore also comprise activities, events, and exceptions to those activities or events, such as travel plan cancellations.

Information items herein are distinct from raw data packets commonly used to transport information payloads, in that information items possess semantic significance independent of the data stream in which they are embedded. Information items may be addressed to a specific user, such as an email sent directly to a particular user, or they may be more general, such as a news item. Information items may be machine generated, such as a book recommendation based on browsing or buying habits of a particular user, or may be created by a living user, such as an email message. Information items may be generated or derived by devices participating in the service, including the local device on which the processing is occurring. For example, the service may generate driving directions for a user after observing a calendar appointment on the user's calendar that occurs at a location to which the user has not yet traveled.

Context is information about the user and the world that is used to process information. Context typically comprises user context, computer context and communication network context. Herein, context may be referred to as “context items”. These different context components are discussed in detail below. In general, any set of information may be designated as context, and, in turn, may be used by a context-based processing system, which is discussed below.

Context may be static, semi-static or situational. Static context is assumed to remain fixed over time for purposes of analysis of information items, as will be discussed below. Examples of static information are a user's identity, date of birth, or blood type. Static information is typically independent and invariant of user situation. Semi-static information comprises information, such as user preferences (news, music, sports, stocks), home address, work phone, etc., which can change over time, but not with great frequency. Often, since semi-static information changes infrequently, the service may consider semi-static context to be static, hence discussions herein may not differentiate between the two classes. Situational information is assumed to change frequently. Examples of situational context are: the user's current activity and location (typically stored in calendars or travel itineraries, for example); the latency to transfer data over a transmission medium; the amount of free storage on a device, etc. Situational information can be extracted directly from a device mechanism (e.g., GPS receiver) or inferred from other sources (e.g. calendar indicates meeting in Chicago, Ill. implying that the user is in Chicago, at a latitude and longitude that can be derived from a mapping software).

The service may transfer information items and/or context between devices in the service. Herein, the context transferred may be referred to as “context” or as a “context item”. As is discussed later, since information items may be utilized as context by the service, any reference to generating (creation) and/or transferring information items herein may imply the generation and/or transfer of context.

Context is typically distributed among devices in the service. Devices attempt to synchronize (i.e., transfer so as to be in agreement, that is, consistent) context information with other devices in the service. As noted below, context may not be perfectly synchronized between devices at all times, for example, due to imperfect connectivity. Context may be updated as deemed necessary, based upon established policy rules (i.e., logical rules) that are internal to the service. Typically, context updating occurs for user status changes such as a change of user location, updates in calendar appointments, change in mode of transportation, change in multi-tasking load, etc.

It would be advantageous to distribute and update both information items and context to devices within a service. Ideally there is information item and context coherency among devices (“coherency” herein)—that is, full, consistent agreement or synchronization of all information items and context between all devices at any given instant in time. Sometimes limitations such as wireless network coverage, device storage capabilities, monetary costs, time delays, etc., can prevent coherency from being achieved or being desirable. Given these constraints and limitations, it would be advantageous to provide the capability of partial, just-in-time transfer of context and information required for service operation for a short period into the future. Mechanisms for transferring information items and context discussed herein comprise both fully coherent and partially coherent distribution of information and context.

Context-based processing typically comprises evaluating information to determine relevance to a user or group of users for tasks and decisions at hand in the short-, medium- and long-term future. This processing may also comprise determining what information items to transfer and determining the best mode of presentation and/or methods of using device capabilities for interaction with the physical and virtual worlds. This processing may comprise prioritizing information items to be transferred to other devices and/or output to the user, and determining the characteristics of the transfer to occur. This processing can take numerous factors into consideration including, but not limited to, device characteristics (e.g., memory size, storage limitations, etc.), window of time to execute the transfer, network characteristics (e.g., bandwidth limitations, channel availability, etc.), user activity and interests, user attention span, and other factors that may dynamically affect processing (e.g. filtering and prioritization) and transfer of information.

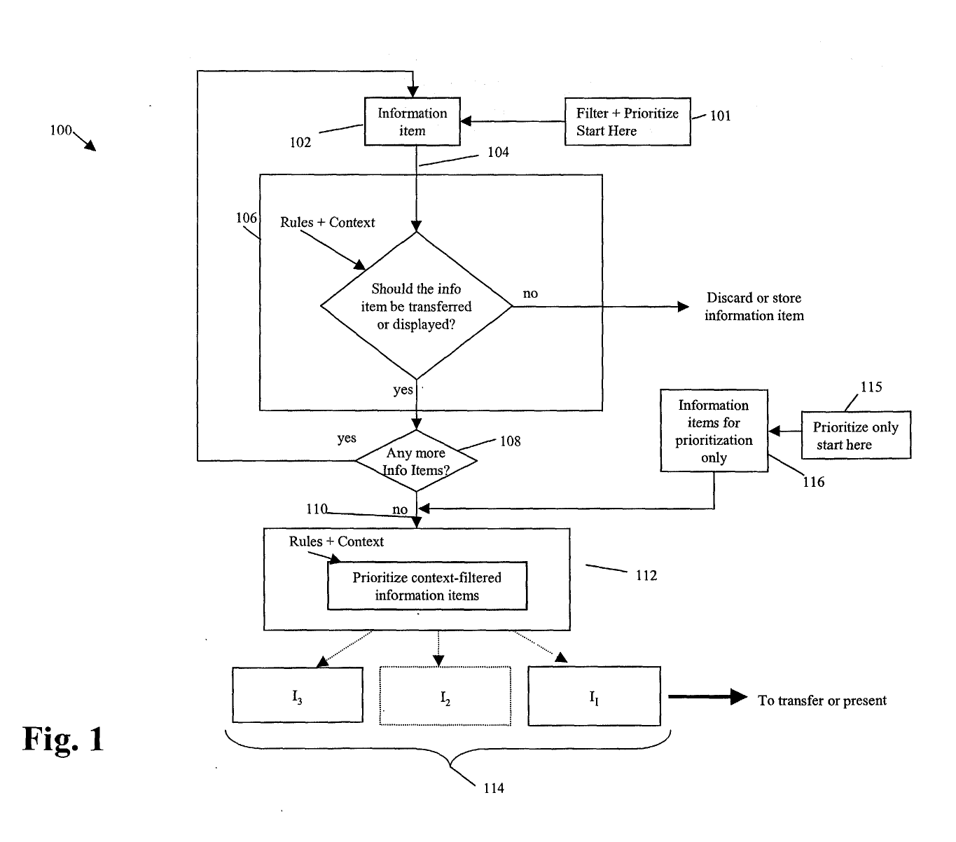

Context-based processing is accomplished by using logical rules in combination with context, which, when applied to an information item, results in a decision as to whether to transfer the information item from one device to another, and may additionally prioritize the information item with respect to other information items to be transferred or output to the user. FIG. 1 shows an embodiment employing context-based processing. A context filter 106 determines if an information item should be transferred or output to the user (“context filtering” herein). The output of the context filter is a plurality of context-filtered information items. A context-based prioritizer 112 performs the prioritization process (“context prioritizing” herein). The output of a context-based prioritizer is a plurality of context-prioritized information items. In an embodiment, both a context filter and a context prioritizer may be present, while in another embodiment only one may be present. The output from the context-based processing is a plurality of context-processed information items. This plurality of context-processed information items may contain context items, as noted above.

The filtering and/or prioritization process may be iterative. In this iterative process, the filtering and/or prioritization may be repeated on the information items at hand. In each successive iteration, different rules and context may be utilized. Additionally, though the service as a whole may be performing both filtering and prioritization, a given iteration may only perform filtering or prioritization, or it may perform both. The service may terminate the iteration when, after evaluating a utility function, it determines that further processing should not be performed. For example, the service may stop iterating if further iteration may: consume too many computational resources; prevent other useful work from being performed (on behalf of another user, for example); is unlikely to substantially change the resulting information items or their priorities; etc.

Iteration has a number of important benefits that impact, for example, context-processing adaptation to changing circumstances (information and context), including quality-of-service issues. First, it allows the service to refine the information items to be displayed or transferred at an increasingly fine granularity, utilizing increasingly more complex (and computationally expensive) rules and context. Second, it allows the service to limit the number of information items transferred or displayed without unduly limiting choices for analysis in early phases of the processing. Third, iteration allows the service to provide useful results at a variety of granularities, allowing the overall service to a“gracefully degrade,” that is, operate at less than full functionality while still providing some useful service. For instance, if the processing load on the device increases due to an increased frequency of new information feeds or asynchronous information requests, less time may be allocated by the service to processing information for a particular user. Or, for example, a deteriorating wireless communication channel (e.g. higher error rates or low bandwidth) may require the service to react by reducing the number of information items to be transferred.

The priority of information to a user is typically evaluated through the use of logical rules in light of the context, through context-based processing. Priority may be assigned as a single numeric attribute, or may include multiple components such as relevance, importance, urgency, etc. In one embodiment a numeric priority rating is calculated based on attributes such as importance, relevance, urgency, etc. As an example, information items are typically determined to be: 1) relevant to the user, 2) not relevant to the user (subcategories may be established, e.g., of lesser relevance, greater relevance, numbered subcategories, etc.), 3) relevant at a future time, or 4) potentially relevant at a future time. Other categories of relevance may likewise be established. Likewise, other attributes of information items are typically determined through the use of logical rules in light of the context through context-based processing. Such attributes may be roughly “binned”, i.e., classified according to finer granularities or subcategories.

Relevance and importance are metrics that are typically assigned to an information item. In an embodiment, the values assigned may be directly related through the logical rules used for evaluation. In this case, for example, in order for an information item to be rated as “highly important,” it also must be deemed to be “highly relevant.” In another embodiment, the metrics may be completely independent. For example, the logical rules may determine that an information item is “highly relevant” to a particular user, but “unimportant” (for example, an email advertisement for an overseas casino operation sent directly to the user). Similarly, for example, the logical rules may determine that an information item is “of little relevance” to a user but “highly important” (for example, an email regarding a security breach sent to all employees at a large corporation, which is deemed highly important because of the content of the message or the sender, but not highly relevant because the email is addressed to thousands of other employees and the relevance is inversely proportional to the number of recipients). The logical rules used to determine relevance and importance may be implemented in a variety of ways; this invention places no limitation on their form.

Priority (and its component metrics) of information items and context to be transferred may be reviewed periodically or continually. A change in an attribute such as relevance, importance, etc., typically influences the context-based processing. Changes to the inclusion or exclusion of information for transfer or display, and the prioritization of the items are typically effected through context-based processing that may occur at any time, including during transfer. The process is called dynamic processing and is discussed in detail below.

In various examples in this specification, scenarios are described in which a change to either importance or relevance impacts the result of context-based processing and the resulting contents and ordering of information items and context to be transferred. These examples illustrate how changes that influence the component attributes of priority can impact context-based processing. Similar impacts can potentially occur for any modification of a priority attribute. Such examples are provided by way of illustration and not of limitation.

Although the discussion of context-based processing focuses on situations where the context-processed information items and context are transferred from one device to another, the use of context-based processing is not limited to these situations. Context-based processing is also applicable in situations where the information items are not transferred to another device, but instead are output to the user using user interfaces (e.g. displays, audio speakers, etc.) that are available to the device performing the context-based processing. Context-based processing is also applicable in situations where the service produces information items that are not output to the user directly, producing, for example, information items that are used by other applications or devices such as, for example, web browsers, or stored for later retrieval. Additionally, context-based processing is applicable for intra-device situations where information items are not transferred to another device, but instead are transferred (herein “intra-device transferring”) between entities or elements within the device such as two applications, or an application and a display.

User context is information about the user, including static information (e.g. name, birth date, etc.), semi-static information (address, food preferences, etc.) and situational information (e.g. current location, current task, next appointment time, email received today, etc.). User context includes the user's identity, additional persons or devices accompanying the user, the nature of an activity being characterized, location, start time and duration of the activity being characterized, along with information that one might find or infer from a calendar, possibly supplemented with other information sources or metadata. “Metadata” herein referring to auxiliary facts or information further annotating, characterizing, organizing, or otherwise related to the information in question that it supplements or transcends. User context may comprise decision-shaping facts such as end-user personal profile/preference information, user history, geographic location of the user as determined by internal or external positioning means, location inferred from calendar appointments accessible by the device, user-established preferences. User context may comprise world context, which, in turn, comprises other decision-shaping factors including profile-shaping factors derived from world conditions. User context is often used as the basis for deriving a representation of the user. Features of such a representation may include the user's current task, disposition, etc. Features of the representation may be calculated for future times. Such feature values may be based upon absolute, predicted or inferred values. User context may be derived and updated through a wide variety of mechanisms, including, for example, examination of the user's calendar, direct user input, location sensors, etc. Information items may serve as a component of user context and, as such, may be used by context-based processing systems to filter and prioritize other information items for display or transfer.

In an alternate embodiment, a subset of user context, called “calendar-focused context”, is used in context-based processing. Calendar-focused context includes task and location information for the user. This context may be determined for the current time or for a time in the past or future. Task, location and other attributes may be explicitly entered by the user, provided by device mechanisms (through sensors, itineraries, etc.) or inferred from other sources (e.g. calendar, email, web services, etc.).

In one embodiment, a subset of user context called “task-focused context” is used in context-based processing. Task-focused context includes the user's current task, task begin and end times (task duration), as well as information concerning other living or non-living entities involved in the task (e.g. meeting participants, etc.). This information may be explicitly entered by the user, or inferred from a variety of sources (e.g. sensors, calendar, etc.)

In one embodiment, a subset of user, device and communication network context called “communication resource context” is used in context-based processing. Communication resource context comprises information about the devices through which a user may be reached at a given time and/or location. For example, communication resource context could include the information that the user may access his office phone, cell phone and desktop computer at his work location. This information may be explicitly entered by the user, or inferred by the service (e.g. network-based caller id, user profile information, etc.).

Computer context is information about the devices in the service. Computer context may include attributes of the hardware, software and operating system profile, which may include, but is not limited to, CPU type, disk size and speed, memory, display, available software, operating system type and version, input/output hardware, security/encryption mechanisms available, authentication methods, etc. Additionally, computer context typically includes information on device usage policies and policy enforcement mechanisms. Also typically included in computer context is situational information such as: power reserves (e.g. battery life) and consumption rates, amount of free space in memory and on disk, current security information, current and scheduled tasks, etc.

Communication network context is information about the communication mediums available to the service. Communication network context comprises network profile attributes including voice network type, data network type, data transfer speed, gateway type, data packet size, cost(s), security, authentication methods, transfer medium characteristics, for transfer media which may include, e.g., wired, wireless, fiber optic, etc. Additionally, network context may include situational information comprising network stability, bandwidth/data transfer rates, connection quality, transfer latencies, error rates, network load, signal strength, cost, Quality of Service, network protocols (e.g. IPv4, IPv6, and associated protocol stack layers (transport, middleware, and application layers, etc)), etc. The communication network can include, but is not limited to, public or private computer networks (e.g. Internet, LANs, WANs, etc.), telecommunication infrastructure, or simple, dedicated private cable(s) or wire(s) linking two devices. The communication network context may also comprise information about network gateway and routing and transport devices such as routers, bridges, hubs, etc. The communication network context may also comprise information about transport policy enforcement devices, often called middle box communication devices, (e.g. network address translators (NATs), firewalls, intrusion detection systems, buffer management systems, proxy servers, rendezvous servers, relay servers, etc.) and any other protocol transparent and non-transparent mechanisms affecting network operation and behavior.

The following are examples of context-based processing:
1) A user is scheduled for a meeting at an unfamiliar location in one hour, but the meeting is cancelled. When the service detects the meeting cancellation event, it cancels delivery of driving directions to the meeting location. This is an example of context filtering.
2) The user has a 25^{th} anniversary within a week's time, for which a high-priority “to-do” item is entered for purchasing some antique silver jewelry. At the current moment, the service detects that the user is within 100 yards of an antique store known to carry jewelry. The to-do item is escalated to the top of the priority queue of items to be transferred and presented to the user, along with directions and the name of the store. This type of context-based processing is an example of filtering and prioritization.

Groups of information items may either be homogeneous or heterogeneous. A homogeneous plurality of information items is a plurality of information items wherein all items are of the same semantic type, even if they are syntactically different. For example, a group of email messages are homogeneous, even though some may be simple text-encoded files and some may be HTML-encoded. A heterogeneous plurality of information items is a plurality of information items wherein the items have a variety of semantic types, although they may be encoded in a similar syntax. For example, email messages and news items may both be encoded as text files, a similar syntax. Since they are semantically different, however, together they form a heterogeneous plurality of information items.

Information items may be transferred from one device to another heterogeneously, which means that the order of transfer of information items is not dependent on semantic category (e.g., email, calendar, to-do list, etc.) of an information item. In a heterogeneous transfer, the categories of information items transferred may be interleaved, so that, for instance, an information item pertaining to a calendar listing may be transferred from a source device to a receiving device, followed by transferring an information item for a to-do list from the source device to the receiving device, followed by an email information item, etc.

Dynamic processing is an ability of a service to change the inclusion or exclusion of information items to be transferred or being transferred and, if required, associated priority order assignments. Dynamic processing typically occurs as a result of: a change in context (e.g., cancellation of a scheduled meeting), new information received, user input, change in network connectivity (e.g. degrading wireless signal, or transitioning from cellular phone data packet network to a local wireless Ethernet connection), the passage of time, or other factors prompting the service to re-evaluate the established set of information items for transfer (e.g, reevaluation of inclusion and prioritization). In discussions that follow, any of the aforementioned changes in context may generate new context that is utilized by the context-based processing system. Dynamic processing may occur any time during the transfer of information items. Inclusion and prioritization of information items may be determined by an external agent or entity and the externally processed results passed back for use by the service. Although repeated reprocessing may take place, the process is still called dynamic processing.

As discussed above, filtering and prioritization is typically performed through a context-based processing of available information items, though the mechanism itself is not dependent on the presence of context-based processing or its usage. In another embodiment, the filtering and/or prioritization mechanisms may be significantly less complex, for example mechanisms that are not context based. The output from dynamic processing may change rapidly due to, e.g., user input, or information received by the device.

Although the discussion of dynamic processing focuses on situations where the dynamically processed information items and context are transferred from one device to another, the use of dynamic processing is not limited to these situations. Dynamic processing is also applicable in situations where the information items are not transferred to another device, but instead are output to the user using user interfaces (e.g. displays, audio speakers, etc.) that are available to the device performing the dynamic processing. Additionally, dynamic processing may be used by a service which does not directly present information to a user, producing, for example, information that is used by other applications or devices such as, for example, web browsers, or stored for later retrieval. Dynamic processing is applicable for intra-device situations where information items are not transferred to another device, but instead are transferred (herein “intra-device transferring”) between entities or elements within the device such as, for example, two applications, or an application and a display.

Dynamic processing may happen at any point that the service has an opportunity to evaluate new context. Specifically, the service, having determined that it will transfer a group of information items, may evaluate context after having transferred only a part of the items (a proper subset of the information items). This may occur, for example, after receiving an information item from another device, after transferring part of an information item to another device (and discovering context relating to the transfer medium, for example) or after the passage of time. The process is highly dynamic and this invention places no limitation on events or actions that may trigger the execution of the process. Note that dynamic processing may occur at any time during transfer of information items to another device (i.e. after having transferred a proper subset of the information items that it plans to transfer). For example, an embodiment may perform dynamic processing after having transferred only a portion of a large information item if it determines that network context has changed relative to the state seen during the last round of processing. Herein, a fractional number of a set of information items is referred to as a proper subset of information items. This dynamic processing occurred after transferring a subset of the information items, which includes a fractional portion of the items that the service intends to transfer.

As an example of dynamic processing, suppose that a source device is transferring information items to a user's Personal Digital Assistant (PDA herein) over a wireless transfer medium. Among the items to be transferred is an email containing a large document file that the service has determined to be potentially of interest to the user, though not of high interest. At the time of initial processing, the source device determined that there was good connectivity with the PDA, and hence this large email message was included in the items to transfer. However, during transfer, after having transferred a proper subset of the information items that the service intended to be transferred, the bandwidth available on the wireless link has dropped significantly. Recognizing this change in the communication network context, the source device dynamically processes the information to transfer to the user, determining that the large email should not be transferred. This determination is not permanent and a subsequent dynamic processing may determine that the large email should be transferred if, for instance, communication network context changes. Dynamic processing of other items may occur as well.

In an embodiment, information deemed relevant to the user is typically updated by transferring updated information to the receiving device(s) from one or more source devices, and may subsequently be displayed at a time deemed appropriate for the user. For example, global weather information is made available to the service. Through context filtering, the device in the service determines that weather information, e.g., weather predictions pertinent to a user's intended travel route, is relevant and should be transferred to a device in the user's possession, such as a PDA and made available for presentation to the user. The weather information may also be utilized for route updating in the event that weather predictions indicate that a change of route is advisable. Typically the service may dynamically process information items in a presentation to the user if, for example, weather predictions indicate that a change in route or schedule is needed. This route updating and dynamic processing may occur on the source device, on the receiving device or both. Both context and information items are typically updated on a periodic basis to the device; updating may also occur a periodically, as needed to respond to changing conditions, e.g., urgently relevant information, new context, user input, etc.

FIG. 1 is a block diagram of one embodiment of a context-based processing system 100. If both filtering and prioritization are to be performed, the process starts at 101. An information item 102 is input through an input port 104. The-context filter 106 comprises context and rules to determine if an information item is to be transferred to another device and/or potentially output to the user. If the information item is to be transferred to another device, it is added to a group of context-filtered information items. If not, it is either stored locally (perhaps for use by other users, or for use at a later time) or deleted from storage on the device. Block 108 determines whether there are additional information items to be passed through the context filter 106. If not, the context-filtered information items are passed to an input port 110 of a prioritizer 112. In the prioritizer 112, comprising rules and context, each context-filtered information item is prioritized with respect to other context-filtered information items, and output as a prioritized context-filtered information item which is placed its prioritized place within a queue 114, to be transferred through a transfer medium (not shown) to a receiving device or output to the user. FIG. 1 shows queue 114, for example, with three prioritized context-filtered items (I₁, I₂ and I₃).

It is also possible to prioritize a set of information items without having first passed through context filter 106, by beginning at 115, and introducing the information items to be prioritized at 116. Prioritizing without filtering may be preferable if, for instance, the set information items were previously context-filtered, or if it is deemed unnecessary to filter the set of information items under consideration. Likewise, some embodiments of the service may context filter the information items without performing prioritization. As discussed above, some embodiments may augment the process of FIG. 1 by iterating. This iteration may utilize filtering in some iterations, prioritization in some iterations and both filtering and prioritization in some iterations.

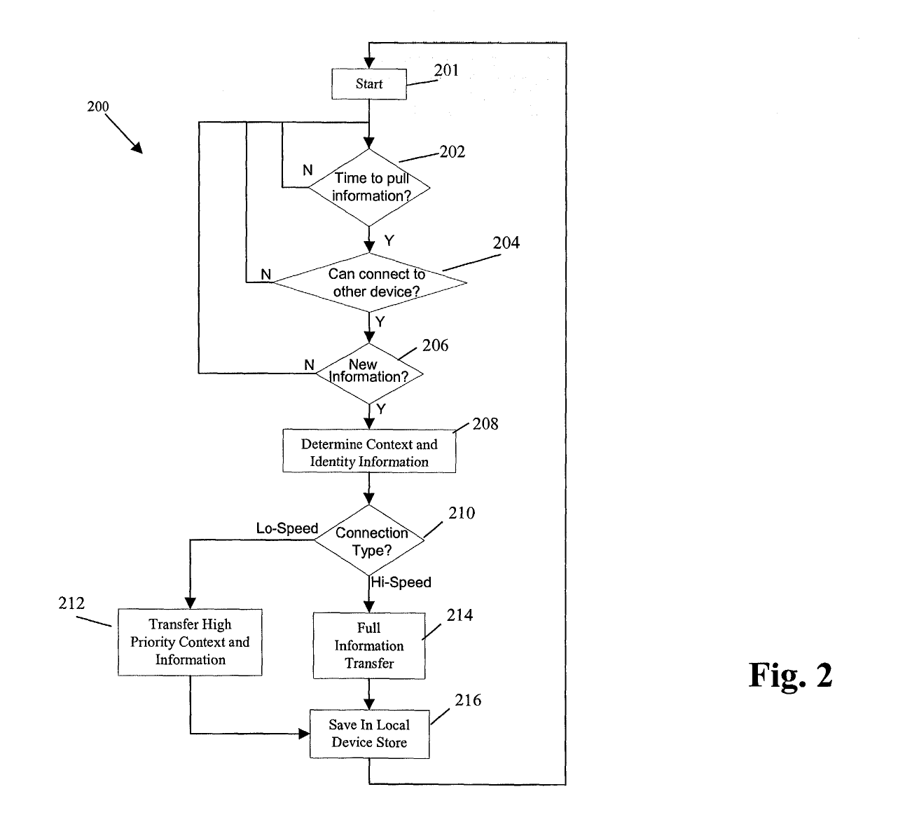

FIG. 2 is a block diagram flowchart of a context-based transfer process, according to an embodiment. In block 202, a scheduler residing within a device periodically “wakes up” and checks to see if it is time to pull information from the other devices. The wake up times may be at predetermined intervals or schedules, triggered by various internal or external events, or, alternatively, the user may request that information be pulled from the another device, or another device can initiate the information transfer. The wake-up schedule can be modified by any component of the service. If no information is to be transferred, the scheduler continues in dormant mode, waiting for the next wake-up call. If it is time to pull information from the other devices, in block 204 the scheduler checks to see if a connection can be established with the other devices. For the purposes of example and illustration, but not by way of limitation, assume that the process 200 is on the receiving device. Note, however, that the process 200 can be found on sending devices as well.

If a connection between the devices is made, in decision block 206, it is determined whether there are information items and/or context to transfer. This decision is made using context-based processing. The order in which the transfers are done can vary or change depending on the information items and/or context already transferred, or to be transferred. If there are information items and/or context to be transferred, in block 208 information items and/or context is prepared for transfer between the devices. In decision block 210, the service determines which connection speed (typically measured in bytes/second or an equivalent measure) is available and/or preferable, e.g., high speed or low speed; multiple connection speeds with varying attributes (cost, security, reliability, etc) may also be possible. If multiple connection paths or types are available between the devices, the service may evaluate device and communication network context and other factors such as, e.g., the prioritization of information, the amount of information to be transferred, or the cost of each available communication type (in, e.g., time, fees, power, etc.), etc. to determine which connection to employ in the transfer. In another embodiment, the service may employ more than one connection in the transfer to optimize, for instance, time, bandwidth, cost, etc. As an example, FIG. 2 shows a service with two connection speeds and a simple model for determining what is to be transferred between the devices. If the connection is low speed, in block 212 a reduced set of information items and/or context is transferred; if high speed, in block 214 a fill set of information items and/or context is transferred. Note that other embodiments may implement more complex handling of connection state. The example shown in FIG. 2 is for illustrative purposes only and does not limit the invention.

In block 216, transferred information is stored in the receiving device, to be utilized by the receiving device for presentation to the user on demand, or for presentation when deemed appropriate by the service or the receiving device, or for transferring to another device. After storing information, the process returns to block 201 and waits for the next initiation or wakeup call.

In another embodiment, information items and context are transferred between devices via a multi-phase transfer process comprising N phases, where N is any positive integer. By way of example, a multiphase transfer process may comprise four phases:
Phase 1 Communication channel and device characteristics determination
Phase 2 Critical information item/context transfer: highest priority transfer
Phase 3 Full information item and context transfer
Phase 4 Prefetch and/or trickle transfer

Each of these phases will now be further described. Presentation to a user may occur simultaneously with the transfer of information, depending on factors such as the receiving device's capabilities.

In Phase 1, the service determines the attributes of communication channels between the communicating devices and characteristics of the devices involved. Communication network characteristics are discussed above as part of the communication network context. Both devices may evaluate communication network context. The communication network context may be represented by a single characteristic (quantitative, semi-quantitative or qualitative) value (“attribute” herein), or by a set of values characterizing the communication network. The communication network context is used by the service to determine the timing and prioritization of information items and/or context to be transferred between the devices. If, for instance, the communication network attributes are determined by the service to be favorable for transfer, the need is lessened for prioritization and immediate transfer of high priority information items and/or context; instead, a full transfer can proceed at maximum transfer rate. If, however, the attributes are unfavorable, then the need for prioritization and transfer of high priority information items and/or context is increased, and thus these information items and/or context are ordered to be transferred first. If, for example, an unsecured communication channel is used, the service might prevent the transfer of sensitive or classified information items and context, e.g. the location or schedule of a very important person (VIP) traveling in hostile geographies. If dynamic processing occurs prior to, or during the transfer, the order of information items and/or context to be transferred may change. Additionally, during phase 1, the service determines device attributes, including, for example, battery status, display capabilities, memory space, etc. This information is incorporated in device context and used in context-based processing.

In Phase 2, transfer of high priority information items and/or context is accomplished. This stage ensures that the receiving device will have information items and/or context of immediate or high importance to a user, which is especially important if connectivity becomes intermittent. If dynamic processing occurs prior to or during the transfer, information items and/or context to be transferred and their ordering may change.

In Phase 3, all information items and/or context deemed important to the user of the device for a short time frame into the future are transferred. If dynamic processing occurs prior to, or during the transfer, the information items and/or context to be transferred and their ordering may change.

In Phase 4, a set of information items and/or context that may be relevant but less important in the short term, or that may have usefulness in the future are transferred. Phases 1, 2, and 3 transfer information projected to be useful in the near-term. The term “prefetch” refers to the transfer of information prior to the time it is needed; that is, fetched in anticipation that it will be needed in the future. Hence phases 1, 2 and 3 target short-term prefetch. The purpose of Phase 4 is to carry out long-term prefetch; that is, the fetching of information projected to be needed farther in the future. The motivation is avoid or lessen the deleterious effects of having to make certain transfers later or not being able to make the transfer at all at a later time. For instance, if a high-bandwidth, low cost communication network is available for a known interval of time, it can be advantageous, both in terms of a user's cost and time, to transfer large information items and/or context, such as, for example, a foreign language translation dictionary, before they are needed on a trip to a foreign country. Similarly, for example, if network connectivity is projected to be unavailable during some period (e.g. the user will be moving into an area known not to have any wireless network coverage), this may be only way to transfer the needed information. Phase 4's long-term prefetch can take advantage of idle time and bandwidth on the communication network, and may be used to improve the service. For example, suppose a user is traveling to Chicago. The service delivers a large file containing a city guide to the user's PDA using a wired connection, while the user is still at home. This transfer occurs well ahead of the user's departure, and without direct user interaction. The prefetch avoids the cost and time of transferring over a wireless communication channel.

For large information transfers Phase 4 can employ a “trickle” transfer mode to accomplish the prefetch operation over multiple connectivity “sessions”, where a session designates a period of continuous connection between two or more devices. Thus a single information item or context is split into smaller chunks at the sending device and then are transferred and reassembled on the receiving device, possibly send only a few of the chunks during any given session. For example, the service may trickle a large city guide to a wireless device, the transfer occurring over several sessions, thus not adversely impacting any one session. Trickle mode transfers may be carried on in the background by the receiving device, while presentation of information items is occurring. The set of information items to be transferred in trickle mode is typically transferred in advance of the time at which the system determines the user needs it and are used to take advantage of unused time and communication network bandwidth. In some cases, it is possible that trickle transfer will not have sent all of the chunks required in time. In this case, the remaining information can be sent on demand (or by phases 2 or 3) and then reassembled. Or, only the information transferred to the device is reassembled and made available for further use without retrieving the remaining information. If dynamic processing occurs prior to, or during the transfer, the information items and/or context to be transferred- and their ordering may change.

Multi-phase transfer enables information to be processed (and, if necessary, filtered and prioritized) and transferred between devices so that critical information items and/or context are assured of being transferred, before those information items and/or context that may not have immediate utility to the receiving device and the user, but which may have utility in the future, e.g., information items and/or context transferred in phase 4. By filtering and prioritizing information items, the service will transfer critical information items and/or context, and in the event of a disconnected state the receiving device is more likely to have access to the essential information items and/or context, enabling it to serve as a decision-and/or delivery mechanism within a service.

This multi-phase transfer process may change in structure through dynamic processing, typically increasing the number of phases by creating and ordering sub-phases, or by reducing the amount of information to be transferred. For example, a change in priority of a portion of information may result in the alteration of priorities within phase 3. Hence information to be transferred in phase 3 may, through inclusion and prioritization established by context-based processing, be assigned a particular ordering, and subsequently transferred in the order established.

The following is an example of dynamic processing: a user has a scheduled meeting at a remote location. The meeting is recorded on the user's master calendar, which is stored on a server. The server has created driving directions for the user to get him from his current location to the location of the meeting. However, the user has canceled the meeting through a calendar program on the user's PDA. During the multi-phase transfer process, the PDA transfers the meeting cancellation information item to the server, prior to the transfer of the driving directions from the server to the PDA. After receiving the cancellation information item, the server, through dynamic processing, eliminates the transfer of the driving directions to the PDA.

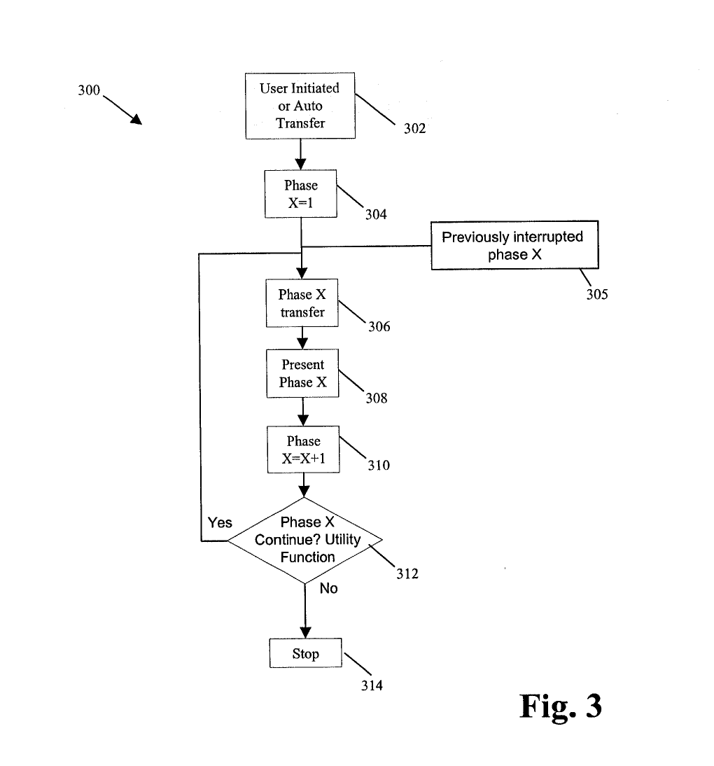

FIG. 3 is a block diagram of the control flow for a multi-phase transfer process. Both the transmitting and receiving devices involved in the transfer process may utilize the same basic control flow; information items and context may be transferred in either direction between devices. In 302, the transfer is begun, either through user initiation or, more typically via an auto-initiation routine. In block 304, the initial phase X=1 is begun. If a phase X was interrupted previously, it can be restarted in block 305. In block 306, the phase X transfer is accomplished through transfer of information items and/or context between the devices. In 308, transferred information items are presented on the receiving device, such as by visual display; alternatively another mode of presentation, such as audio presentation, may occur, or an action may be executed by the receiving device, or items may be stored on the device for display or execution in the future. In block 310 the control flow advances to the next phase X+1.

In decision block 312 a continuation utility function is invoked. The utility function determines if it is desirable to proceed to the next synchronization phase X+1. Utility function parameters may comprise transmission channel quality, presence of additional information to be transferred, time and byte-count limitations, monetary costs, available energy to power the device, and other factors. The utility function permits inter-phase evaluation and adaptation, including dynamic processing. If the answer to the utility function evaluation is “yes,” (i.e. continue iteration) the control loops back to block 306, where Phase X+1 is initiated. If the utility function evaluation yields “no,” the control flow proceeds to block 314. The sending or receiving device(s) may determine that the process should terminate. For example, suppose that a user's PDA and a server on the Internet are involved in the phase X process. The PDA may, for example, terminate the phase X process at block 314 because, e.g., the PDA is running out of storage (e.g. flash memory space) or running low on battery power. The server may, for example, terminate the process if the user has exceeded a certain bandwidth limitation, or if the server has become overloaded.

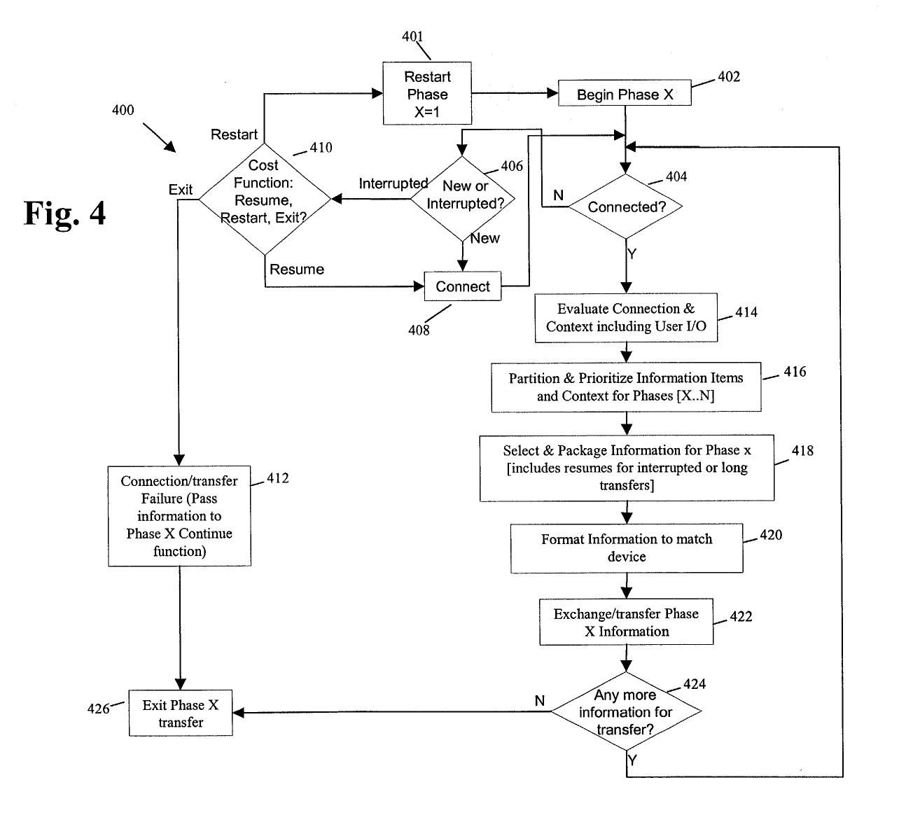

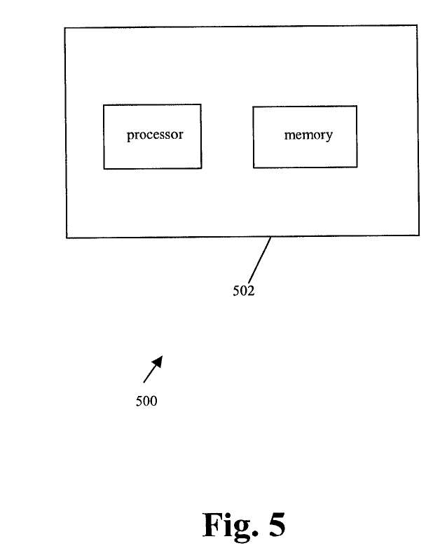

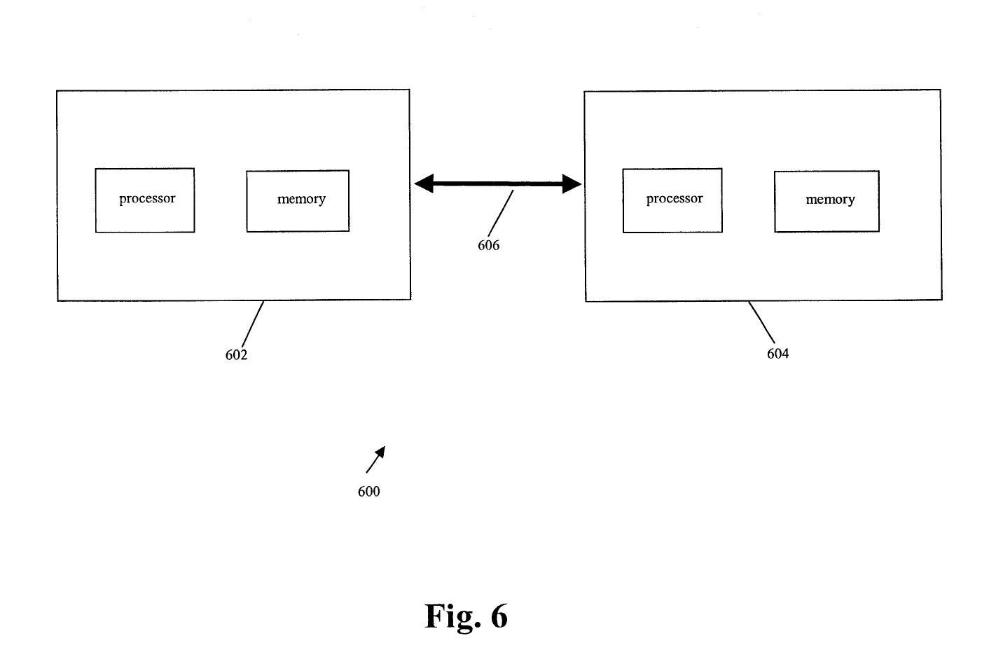

FIG. 4 is a block diagram,of a single phase of the multi-phase transfer process (item 306 in FIG. 3). As discussed above for FIG. 3, each device involved in the transfer process may employ the same basic control flow described here. In this description and in FIG. 4, X is any of the N phases in an N-phase transfer, according to an embodiment. In 402 Phase X is begun. In decision block 404 an evaluation is made as to whether the source device and receiving device are connected. If the answer is “no,” a second evaluation is made in block 406, as to whether the connection is new or interrupted. If the connection is new, in block 408 the connection is made, and the process flow continues after passing through decision block 404. If the evaluation result in decision block 406 is that the connection is interrupted, another decision is made in block 410, through the use of another utility function. The utility function in decision block 410 evaluates whether it is best to resume, restart or exit. If the utility function indicates resume, process flow proceeds to block 408, where connection is again attempted. If restart is indicated, process flow goes to block 401, where Phase 1 is begun again. If the Utility function indicates exit is most appropriate because of, for instance, a connection or transfer failure, process control flow passes to block 412. Process flow exits from Phase X at 426 after connection-failure cleanup is finished in block 412.

If, as determined in decision block 404, the devices are connected, in block 414, context is evaluated because network connection attributes and other context may change over time, even within a given transfer phase. Additionally, user input is part of context, which can change those information items that are included in the transfer between the devices and their dynamic processing results. User input, a change in context, or information items, can result in a change in the inclusion or exclusion of information items (and other associated metadata, e.g. priorities, etc, as required); i.e., dynamic processing, of information items and/or context to be transferred within a phase. User input results may be transferred from one device to the other device.

In block 416 the information items and/or context are partitioned and processed for the current phase, and possibly for future phases. Here again the service may dynamically process information items and/or context to be transferred.

In block 418, information items and/or context are packaged for transfer. In block 420 formatting of information items and/or context is done in order to match the receiving device capabilities and format expectations (e.g. web browser for a laptop, or text-to-speech for a phone/voice interface, etc.). In block 422, the information items and/or context are transferred. Transfer may be bi-directional, with both devices sending information items and/or context. In decision block 424, it is determined whether there are additional information items and/or context to be transferred: if “yes,” the process begins again with decision block 404. If there are no more information items and/or context to be transferred, this phase of the transfer process is complete, and the process flow ends at block 426 (resuming control flow in FIG. 3 at block 308).

Some of the features of single phase or multi-phase transfer processes may comprise:
Information items and/or context transferred may be partitioned into sets. These sets may comprise heterogeneous (semantically diverse) information items and/or context, and varying item sizes.
Dynamic processing makes the transfer process adaptive in nature. A given phase may comprise zero or more iterations of a primary loop comprising:
Connection check and/or reestablishment/restart/recovery
Evaluation of context, including the current device-to-device network connection and any recent user inputs. Context may affect the processing (e.g. inclusion and priorities) of information items and/or context to be transferred. User input results may or may not be transferred and may be acted upon depending on the context. For example, a user request for an entertainment news item might be replaced by the higher prioritization of flight cancellation information and rebooking alternatives
Processing (e.g. partitioning, filtering and prioritizing) information items and/or context for the current phase as well as for subsequent phases. In a simple degenerate implementation, all transfers are computed statically in phase 1. Prioritizing is typically based upon context-based processing
Transcoding , i.e., formatting information items and/or context in a manner that matches the receiving device capabilities
Executing the information item and/or context transfer
Iterating
A hierarchy exists around which algorithms, iteration, and transport are built. The hierarchy includes: plurality of information items, Information item, and Information packets.

Information items may be constructed from one or more information packets. Context can also be broken into one or more information packets. An information packet does not necessarily have semantic significance as does an information item. Information packets may often equate to the network protocol data packets in an embodiment, but can also be distinct in an embodiment. For example, in an embodiment, a calendar entry may be represented by a single information packet while an city travel guide might be represented by a set of information packets. Information packets may comprise ordering information so that they may be assembled in the correct order, error detection and correction, encryption information, etc.
Iterations may be organized around the transfer/receipt of information items and/or context, or a finer granularity. Information packets are typically the smallest unit of information transfer; some information items may comprise multiple packets. Common forms of information items, such as basic calendar entry information, may form a single packet. The iteration in the process may occur only at information item boundaries, at information packet boundaries or any other point. As discussed above, dynamic processing may be triggered by any event.
Information items and/or context items may be sent in differential or non-differential forms. Differential form means that only differences between information items and/or context residing on a source device and a receiving device, i.e., updates, are transmitted.
Loop iterations are permitted at an information item and/or context level or a transmitted packet level, affording a high level of flexibility and adaptation., Factors such as changing connectivity conditions, user context, and user inputs, may be adapted to quickly with a low latency.
Utility functions are employed to evaluate continuing processing at a fine granularity. FIG. 5 shows a system 500 according to an embodiment of the invention. A device 502 comprises a processor and memory. One or more information items may be processed at the device 502. Processing may comprise context-filtering, prioritizing, or both context-filtering and prioritizing. One or more processed information items may be provided to a user, stored or transferred. Processed information items may be transferred within the device 502, such as from one software application to another software application; alternatively, processed information items may be transferred outside of the device 502.

FIG. 6 shows another embodiment of a system according to the invention. A device 602 comprises a processor and memory. One or more information items may be processed at the device 602. Processing may comprise context-filtering, prioritizing, or both context-filtering and prioritizing. One or more processed information items may be provided to a user, stored or transferred. For example, information items may be provided to the user through an attached display. A second device 604 comprising a processor and memory may receive one or more processed information items. The second device 604 may provide one or more processed information items to a user; store one or more processed information items; or transfer one or more processed information items.
The operations described above can be stored in the memory of a computer system as a set of instructions to be executed. In addition, the instructions to perform the operations described above could alternatively be stored on other forms of machine-readable media, including magnetic and optical disks. For example, the operations of one embodiment could be stored on machine-readable media, such as magnetic disks or optical disks, which are accessible via a disk drive (or computer-readable medium drive). Further, the instructions can be downloaded into a computing device over a data network in a form of compiled and linked version.
Alternatively, the logic to perform the operations as discussed above, could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.); etc.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

1. A method comprising:
transferring a proper subset of a first plurality of information items;
receiving at least one information item separate from the first plurality of information items;
forming a second plurality of information items including the first plurality of information items and the at least one information item; and
processing the second plurality of information items, providing at least one dynamically processed information item.

2. The method of claim 1 wherein processing comprises one of filtering, prioritizing, and filtering and prioritizing.

3. The method of claim 2 wherein, when processing includes prioritizing, the method further comprises:
transferring, in prioritized order, at least two dynamically processed information items.

4. The method of claim 1 wherein the second plurality of information items comprises a complement of the proper subset of the first plurality of information items, the complement comprising information items within the first plurality of information items that are not in the proper subset of the first plurality of information items.

5. The method of claim 1 wherein the first plurality of information items is heterogeneous.

6. The method of claim I wherein the second plurality of information items is heterogeneous.

7. The method of claim 1, wherein at least one of the first plurality of information items is received from a user input.

8. The method of claim 1, wherein at least one of the second plurality of information items is received from a user input.

9. The method of claim 1, wherein at least one of the first plurality of information items is received from a separate second device.

10. The method of claim 1, wherein at least one of the second plurality of information items is received from a second device.

11. The method of claim 1 further comprising promoting a dynamically processed information item to a user-accessible state.

12. The method of claim 1, wherein when processing comprises prioritizing, providing includes presenting in prioritized order.

13. The method of claim 1 further comprising transferring a dynamically processed information item to a separate second device.

14. The method of claim 1 further comprising intra-device transferring a dynamically processed information item.

15. A machine readable medium, having stored thereon, a set of instructions, which when executed, cause a machine to perform a method comprising:
transferring a proper subset of a first plurality of information items;
receiving at least one information item separate from the first plurality of information items;
forming a second plurality of information items including the first plurality of information items and the at least one information item; and
processing the second plurality of information items, providing at least one dynamically processed information item.

16. The machine readable medium of claim 15 wherein processing comprises one of filtering, prioritizing, and filtering and prioritizing.

17. The machine readable medium of claim 16 wherein, when processing includes prioritizing, the method further comprises:
transferring, in prioritized order, at least two dynamically processed information items.

18. The machine readable medium of claim 15 wherein the second plurality of information items comprises a complement of the proper subset of the first plurality of information items, the complement comprising information items within the first plurality of information items that are not in the proper subset of the first plurality of information items.

19. The machine readable medium of claim 15 wherein the first plurality of information items is heterogeneous.

20. The machine readable medium of claim 15 wherein the second plurality of information items is heterogeneous.

21. The machine readable medium of claim 15, wherein at least one of the first plurality of information items is received from a user input.

22. The machine readable medium of claim 15, wherein at least one of the second plurality of information items is received from a user input.

23. The machine readable medium of claim 15, wherein at least one of the first plurality of information items is received from a separate second device.

24. The machine readable medium of claim 15, wherein at least one of the second plurality of information items is received from a separate second device.

25. The machine readable medium of claim 15 further comprising promoting a dynamically processed information item to a user-accessible state.

26. The machine readable medium of claim 15, wherein when processing comprises prioritizing, providing includes presenting in prioritized order.

27. The machine readable medium of claim 15 further comprising transferring a dynamically processed information item to a separate second device.

28. The machine readable medium of claim 15 further comprising intra-device transferring a dynamically processed information item.

29. An apparatus comprising:
a first unit to transfer a proper subset of a first plurality of information items;
a second unit, connected to the first unit, to receive at least one information item separate from the first plurality of information items;
a third unit, connected to the second unit, to form a second plurality of information items including the first plurality of information items and the at least one information item; and
a fourth unit, connected to the third unit, to process the second plurality of information items, providing at least one dynamically processed information item.

30. The apparatus of claim 29 wherein the processing of the fourth unit comprises one of filtering, prioritizing, and filtering and prioritizing.

31. The apparatus of claim 30 wherein, when the processing of the fourth unit includes prioritizing, the fourth unit further transfers, in prioritized order, at least two dynamically processed information items.
